(19) United States
(12) Patent Application Publication
(10) Pub. No.: US 2017/0169351 A1
(43) Pub. Date: Jun. 15, 2017

(54) HETEROGENOUS NETWORK (R-KNOWLEDGE) FOR BRIDGING USERS AND APPS VIA RELATIONSHIP LEARNING

(71) Applicant: TCL RESEARCH AMERICA INC., San Jose, CA (US)

(72) Inventors: LIFAN GUO, San Jose, CA (US); HAOHONG WANG, San Jose, CA (US)

(21) Appl. No.: 14/965,280

(22) Filed: Dec. 10, 2015

(51) Int. Cl. G06N 7/00; G06N 99/00

(52) U.S. Cl. CPC G06N 7/005; G06N 99/005

(57) ABSTRACT

The present invention provides a method a method for learning and using relationships among users and apps on a mobile device. The method includes collecting user profile information and app profile information on the mobile device and obtaining ontology knowledge on contexts and relationships. The user profile information is associated with users including one or more owners of the mobile device and one or more people whose information have been accessed on the mobile device. The method further includes generating a network model based on the user profile information, the app profile information and the ontology knowledge. The network model is a heterogeneous information network model that links the users and the apps. Further, information based on the generated network model are outputted, which at least one of a role of a user, a relationship between two apps or app functions, and a recommended apps list.

### FIELD OF THE DISCLOSURE

The present disclosure relates to the field of information technologies and, more particularly, relates to a method and system for learning and using relationships among users and apps of mobile devices.

### BACKGROUND

Nowadays, increasing numbers of smart phone users resort to mobile devices, rather than traditional devices, for entertainment, education, navigation, productivity, social networking, communications, etc. The iOS AppStore has more than 350 thousand apps and more than 10 billion downloads. From many perspectives including manufacturers of these devices, advertisers, app developers, etc., it is important to understand what, when, and where the mobile users do with the applications.

While activity profiling in a personal computer has been well understood, the same area of mobile devices is hindered by the following factors. User profiling in the personal computer is primarily done via browser cookies, while apps by their nature do not use browser cookies and do not have a way of sharing an identity on a top level to build a profile. Further, although some methodologies to profile user in a mobile operating system have been proposed, they are limited in profiling a single user while ignoring the intrinsic network between multiple users. In addition, along with widely implemented touch screens in various digital electronics and appliances, future apps may be automatically connected together, resonate with true user needs, and fit into the user lives within the existing digital ecosystem.

The disclosed method and system are directed to solve one or more problems set forth above and other problems.

### BRIEF SUMMARY OF THE DISCLOSURE

One aspect of the present disclosure provides a method for learning and using relationships among users and apps on a mobile device. The method includes collecting user profile information and app profile information on the mobile device. The user profile information is associated with users including one or more owners of the mobile device and one or more people whose information have been accessed on the mobile device. Ontology knowledge on contexts and relationships may be obtained. The ontology knowledge includes a plurality of predefined concepts, features of the concepts, and relationships between the concepts. The method further includes generating a network model based on the user profile information, the app profile information and the ontology knowledge. The network model is a heterogeneous information network model that links the users and the apps. Further, information based on the generated network model are outputted. The outputted information includes at least one of a role of a user, a relationship between two apps or app functions, and a recommended apps list.

Another aspect of the present disclosure provides a system for learning and using relationships among users and apps on a mobile device on a mobile device, including one or more processors. The one or more processors are configured to collect user profile information and app profile information on the mobile device and obtain ontology knowledge on contexts and relationships. The user profile information is associated with users including one or more owners of the mobile device and one or more people whose information have been accessed on the mobile device. The ontology knowledge includes a plurality of predefined concepts, features of the concepts, and relationships between the concepts. The one or more processors are further configured to generate a network model based on the user profile information, the app profile information and the ontology knowledge. The network model is a heterogeneous information network model that links the users and the apps. Further, information based on the generated network model are outputted. The outputted information includes at least one of a role of a user, a relationship between two apps or app functions, and a recommended apps list.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary environment incorporating certain embodiments of the present invention;

FIG. 2 illustrates an exemplary computing system consistent with the disclosed embodiments;

FIG. 3 illustrates an exemplary system for learning and using relationships among users and apps consistent with the disclosed embodiments;

FIGS. 4 illustrates a structural diagram of an exemplary relationship learning module consistent with discloses embodiments;

FIG. 5 illustrates an exemplary process for learning and using relationships among users and apps consistent with the disclosed embodiments;

FIG. 6 illustrates a system architecture of an exemplary R-knowledge network model consistent with the disclosed embodiments;

FIG. 7 illustrates a structural diagram of an exemplary user relationship topic model consistent with the disclosed embodiments;

FIG. 8 illustrates an exemplary process for using relationships among users and apps consistent with the disclosed embodiments; and

FIG. 9 illustrates usage scenarios of an exemplary R-knowledge network model consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

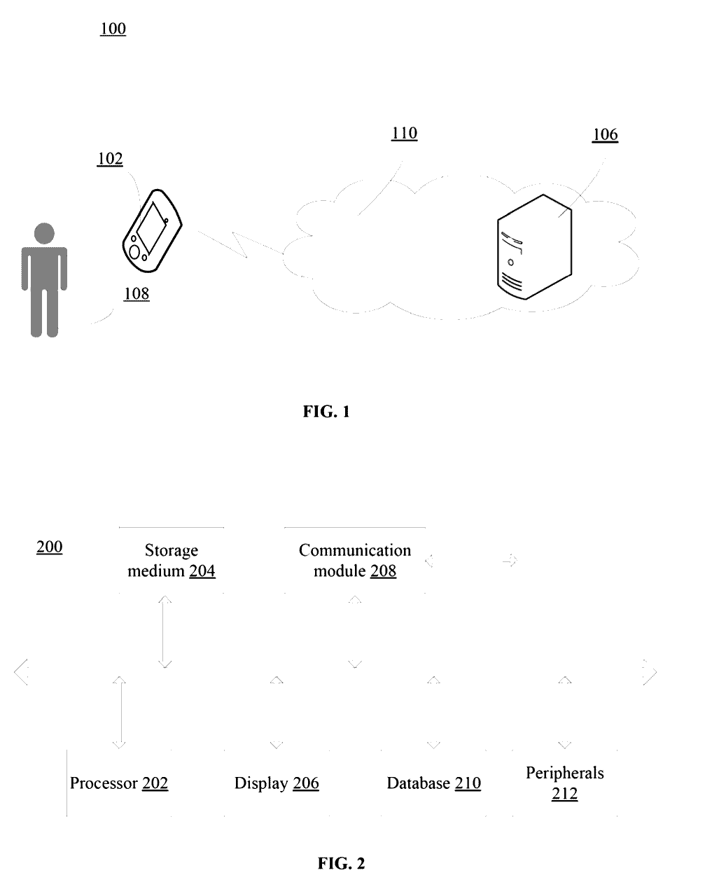

FIG. 1 illustrates an exemplary environment 100 incorporating certain disclosed embodiments. As shown in FIG. 1, environment 100 may include a mobile terminal 102, a server 106, a user 108 and a network 110. Certain device(s) may be omitted and other devices may be added. A user 108 may operate mobile terminal 102 for certain services provided by server 106. Although only one server 106 and one mobile terminal 102 is shown in the environment 100, any number of terminals 102 or servers 106 may be included, and other devices may also be included.

Mobile terminal 102 may refer to any appropriate user terminal with certain computing capabilities, such as a hand-held computing device (tablet), a smart phone or mobile phone, or any other user-side mobile computing device, or any other user-side computing device. Mobile terminal 102 may be implemented on any appropriate mobile computing platform. Mobile terminal 102 may be used by user 108 to connect to network 110 and make requests to server 106. The mobile terminal 102 may obtain information from any appropriate sources, such as from a local storage device, from a wired or wireless network device of a service provider, or from the Internet. The mobile terminal 102 may also be configured to access the functionalities of various applications for varying computing environments. For example, the mobile terminal 102 may be configured to execute apps stored on the mobile terminal 102.

Further, the server 106 may refer to one or more server computers configured to provide certain server functionalities (e.g., a search server), such as data query and computation tasks. The server 106 may include one or more processors to execute computer programs in parallel. The server 106 may store data (e.g., app descriptions) to be accessed by the mobile terminals and other computation applications (e.g., an app search and recommender engine).

Although server 106 is shown in a single computer configuration, more computers or server clusters can be included in server 106. Server 106 may provide cloud-based services in a cloud computing environment, i.e., the use of computing resources (hardware and software) that are delivered as a service over a network infrastructure (e.g., the Internet). The cloud computing environment may include any private cloud configuration and/or public cloud configuration. Various servers 106 (i.e., server services) in the cloud may be configured to provide data storage and computation functionalities (e.g., establishing a heterogeneous network describing relationships among users and apps).

Mobile terminal 102 and server 106 may communicate with each other through communication network 110, such as the Internet or other types of computer networks or telecommunication networks, either wired or wireless, such as a cable network, a phone network, and/or a satellite network, etc.

Mobile terminal 102 and/or server 106 may be implemented on any appropriate computing circuitry platform. FIG. 2 shows a block diagram of an exemplary computing system 200 capable of implementing mobile terminal 102 and/or server 106.

As shown in FIG. 2, computer system 200 may include a processor 202, a storage medium 204, a display 206, a communication module 208, a database 210, and peripherals 212. Certain devices may be omitted and other devices may be included.

Processor 202 may include any appropriate processor or processors. Further, processor 202 can include multiple cores for multi-thread or parallel processing. Processor 202 may execute sequences of computer program instructions to perform various processes, such as an image processing program. Storage medium 204 may include memory modules, such as ROM, RAM, flash memory modules, and erasable and rewritable memory, and mass storages, such as CD-ROM, U-disk, and hard disk, etc. Storage medium 204 may store computer programs for implementing various processes, when executed by processor 202.

Further, communication module 208 may include network devices for establishing connections through the network 110. Database 210 may include one or more databases for storing certain data (e.g., user data and app data) and for performing certain operations on the stored data, such as database searching and data retrieving.

Display 206 may include any appropriate type of computer display device or electronic device display (e.g., CRT or LCD based devices, touch screens). Peripherals 212 may include various sensors and other I/O devices, such as camera, motion sensors, position sensors, keyboard, mouse, etc.

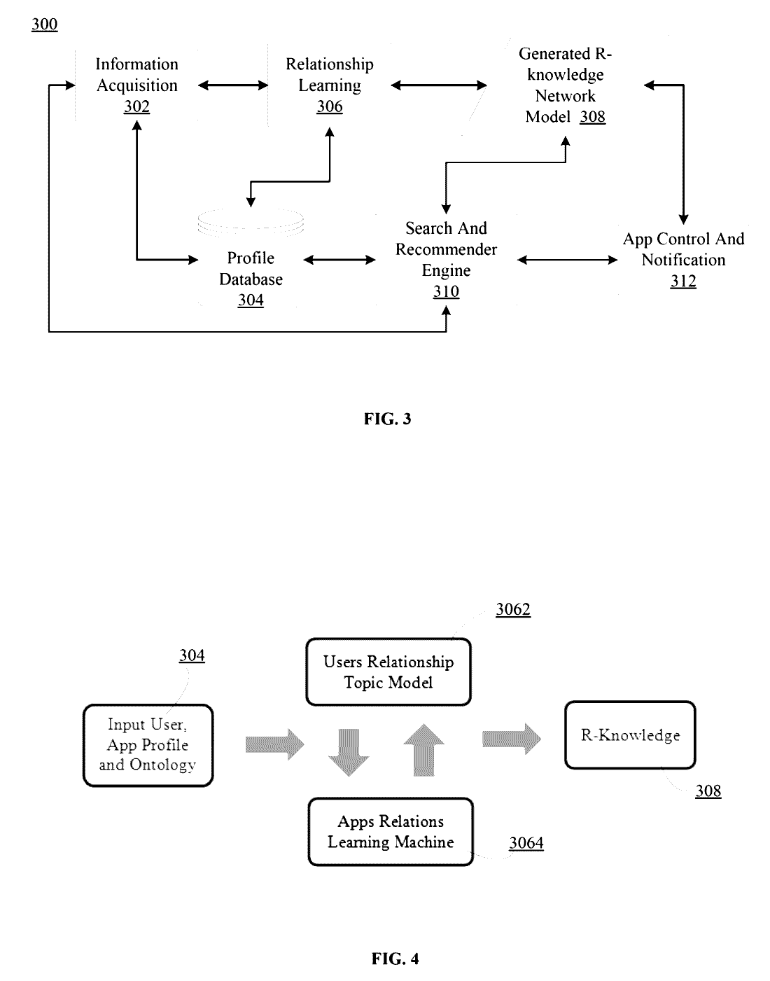

In operation, mobile terminal 102 and/or server 106 may learn and utilize relationships among users and apps. For example, mobile terminal 102 and/or server 106 may make certain recommendations and/or decisions based on the learned relationships. FIG. 3 illustrates an exemplary system for learning and utilizing relationships among users and apps consistent with the disclosed embodiments.

As shown in FIG. 3, system 300 may include an information acquisition module 302, a profile database 304, a relationship learning module 306, a search and recommender engine 310, and an app control and notification module 312. Certain components may be omitted and other components may be included.

The information acquisition module 302 may be configured to collect user profile information and app profile information in a mobile device (e.g., mobile terminal 102). A user, as used herein, may include the mobile device owner(s) and one or more people interacting with the owner(s) on the mobile device (e.g., family, friends, classmates, colleagues, acquaintances, following accounts on the Internet, celebrities) and whose information have been accessed on the mobile device, such as a name in the contact list, a friend on a social network app, an acquaintance exchanged email or text with the owner, a celebrity the owner checked on the mobile device, etc.

The user profile information of a user may include unique data concerning the particular user and activity stream app data of the user. The unique data concerning the particular user may include age, gender, photos, experience, location, favorites, etc. The activity stream app data of the user may include stream data accessed by one or more apps based on user activities. For example, when a messaging app on the mobile device receives a message from a user, the activity stream data of the user may include time and content of the message accessed by the messaging app, and the name of the messaging app.

The activity stream app data may be represented and described by texts. Various types of textual information associated with a user may be included, such as messages, contacts, emails, browsing and search histories, etc. Further, when the user is an owner of the mobile device, the activity stream app data may include app log data which records the app usage activities of the owner, such as time stamps of app usage chronologically, functions called by the apps, and inputted and outputted data from the apps, etc.

The app profile information may include a number of apps installed on the mobile device, app log data including time stamps of app usage chronologically, descriptions of the apps, functions called by the apps, and inputted and outputted data from the apps, etc. The information acquisition module 302 may use the app log data to obtain usage frequency and duration information of an app, and apps or app functions that often used sequentially.

The information acquisition module 302 may be further configured to collect the user data from the mobile device and from a server/cloud (e.g. server 106). For example, the information acquisition module 302 may read the memory of the mobile device and sensor data of the mobile device to obtain user profile information and app profile information. The sensor data may include time, location, photos, battery level and other data that may be collected by sensors installed on the mobile device. Further, the descriptions of the apps and some profile information may be obtained from the server. The information acquisition module 302 may collect the data periodically or triggered by a certain event, such as an instruction from the user or from an application program.

The relationship learning module 306 may be configured to generate an R-knowledge network based on the user profile information, the app profile information and ontology knowledge. The relationship learning module 306 may also be referred to as a mutual enhanced users and apps learning module.

The ontology knowledge may include a plurality of predefined concepts, features of the concepts, and relationships between the concepts. In an exemplary embodiment, the ontology knowledge may include a controlled vocabulary which is structured into a hierarchical taxonomy, where the key domain concepts are found. The vocabulary may include abstract entities describing physical or conceptual objects, such as persons, activities, locations, digital devices, etc. A hierarchy of related concepts may be formed using parent and/or child classes. Types, properties, and interrelationships of these concepts may be configured. Therefore, based on the ontology knowledge, logic reasoning may be performed on context information.

The generated R-knowledge network model 308, as used herein, may refer to a heterogeneous network model having various nodes and links, describing relationships between users, relationships between apps and relationships between users and apps, and providing an interface for accessing and using the network data and analysis. The R-knowledge network may leverage rich semantics of nodes and links. The R-knowledge network may include two objects: users and apps. A user may have links to one or more other users and links to one or more apps. An app may have links to one or more other apps and links to one or more users. That is, the R-knowledge network model may discover hidden relationships between users and apps.

FIG. 4 illustrates a structural diagram of an exemplary relationship learning module consistent with the disclosed embodiments. In an exemplary embodiment, the relationship learning module 306 may include a user relationship topic model module 3062 and an apps relations learning module 3064.

The user relationship topic model module 3062 may be configured to apply a user relationship topic model to obtain relationships between users based on the user profile information and the ontology rules. The apps relations learning module 3064 may be configured to obtain relationships between apps according to app descriptions and correlations sequentially used apps.

Based on the results obtained from the user relationship topic model module 3062 and the apps relations learning module 3064, the relationship learning module 306 may be further configured to generated an R-knowledge network model. The generated R-knowledge model may include information about recognized relationship between users, recognized app function sequence, recognized app usage pattern of the mobile device owner, etc.

Returning to FIG. 3, the app control and notification module 310 may be configured to control apps or send notification to a user according to the generated R-knowledge network model. The app control and notification module 310 may perform certain activities when certain types of triggering events are detected. A specific condition and an activity corresponding to the specific condition may be preset or defined by a user.

In one embodiment, the type of triggering events may be a search query, and the activity associated with the triggering events may be obtaining information from the R-knowledge network. Based on the search query, the app control and notification module 310 may output information about a role of a user, relationships of apps or a recommending apps list according to the generated R-knowledge network.

In another embodiment, the type of triggering events may be the mobile device owner is interacting with a user (e.g., sending or receiving a communication with another user) or the mobile device owner is searching a user, the activity corresponding to the condition may be notifying the mobile device owner about their relationship. In some embodiments, besides notifying the mobile device owner about the relationship with the user, the app control and notification module 310 may be further configured to present profile information of the user and apply personalized settings on the interactions of the user. For example, the app control and notification module 310 may allow the mobile device owner to configure personalized label, font, ringtone or other settings on users in a same relationship group.

In another embodiment, the type of triggering events may be a recognized app function sequence obtained from the R-knowledge network model. The app control and notification module 310 may be configured to prompt the user to allow automatic app function execution procedure in the future when a recognized app function sequence is performed.

In operation, the information acquisition module 302 may collect user profile information and app profile information, and send the collected information to the relationship learning module 306. The relationship learning module 306 may generate an R-knowledge network based on the user profile information, the app profile information and ontology knowledge. Further, a user relationship topic model and app relations may be obtained to generate the R-knowledge network model. The app control and notification module 310 may control apps or send notification to a user according to the generated R-knowledge network model to keep the user informed, allow personalized settings and enhance user experience.

In some embodiments, the system 300 may further include profile database 304 configured to store the user profile information and the app profile information collected from the information acquisition module 302 and update related profile information when the relationship module 306 discovers hidden relationships from the generated R-knowledge network 308. The profile database 304 may include a local database on the mobile device, or a database on a cloud/server, or a combination of both.

In some embodiments, the system 300 may further include search and recommender engine 310 configured to search information and recommend apps from the internet and/or from the generated R-knowledge network model. For example, the information acquisition module 302 may query the search and recommender engine 310 to obtain the descriptions of the apps and some profile information of some users. In another example, the search and recommender engine 310 may combine information from the Internet (e.g., rankings in an App store, online app reviews) and the generated R-knowledge network model (e.g., recognized usage patterns and preferences of a user) to recommend an app list to a user.

Thus, the system 300 may profile users on a mobile device, improve the device, applications, activities, advertisements and the experience to the user. The network between users may be used to discover and mine hidden information and may be further used for a recommender system. Further, the system 300 may automatically connect apps together to resonate with true needs of users and fit into their lives within the existing digital ecosystem.

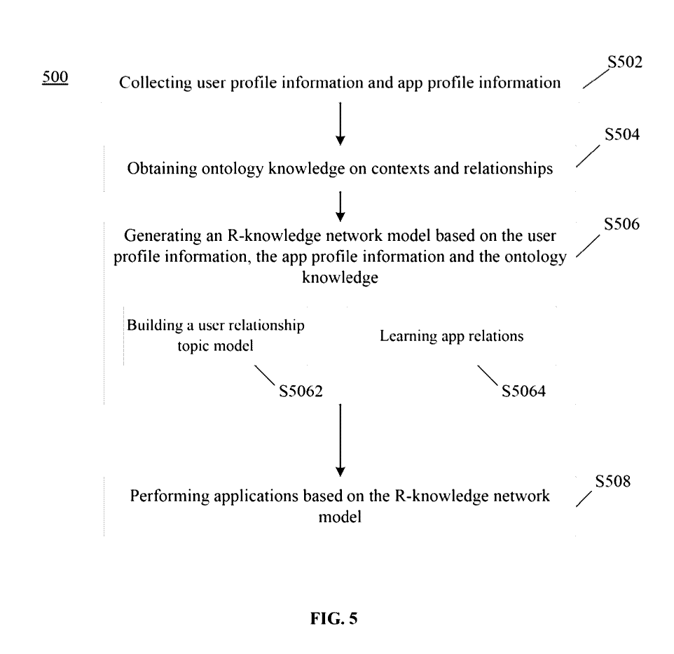

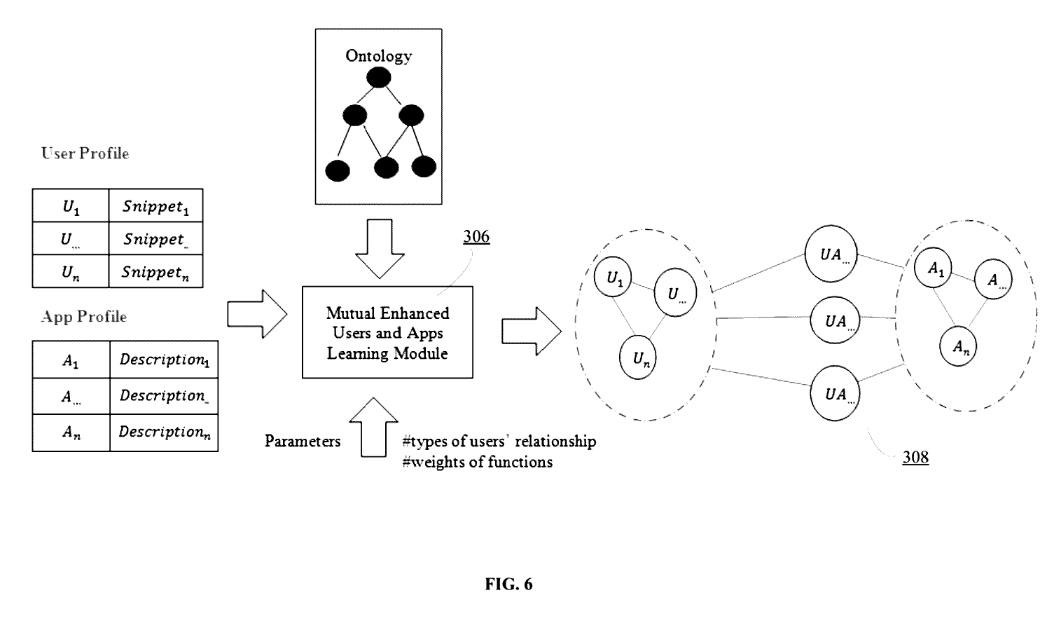

FIG. 5 illustrates an exemplary process for learning and utilizing relationships among users and apps consistent with the disclosed embodiments. In the exemplary process 500, an R-knowledge network model may be established (e.g., by system 300). FIG. 6 illustrates a system architecture of an exemplary R-knowledge network model consistent with the disclosed embodiments.

As shown in FIGS. 5 and 6, in a mobile device, user profile information and app profile information may be collected (S502), for example, by information acquisition module 302 and stored in a database (e.g., profile database 304). A user profile may include two parts, a digital representation of the unique data concerning a particular user and activity stream app data of the user.

The digital representation of the unique user data may be received from user inputs or be automatically collected from a social network of the user, such as age, gender, ethnic, hobbies, contacts, etc. The activity stream app data may be collected on the mobile device via the mobile operating system. The activity stream app data may be represented as text snippets. In some embodiments, the user profile data may be forwarded to a server (e.g., server 106) to be stored, processed and analyzed.

An app profile may include text description of an app. The app may be installed on the mobile device. The text descriptions may be collected from the App Store. The app profile may include app profiles of apps installed on the mobile device. In some embodiments, the app profile may further include app profiles of apps uninstalled from the mobile device and/or popular apps in various categories from the App store but not currently installed on the mobile device.

Further, ontology knowledge may be obtained (S504). An ontology may present a controlled vocabulary which is structured into a hierarchical taxonomy, where the key domain concepts are found. The vocabulary may include abstract entities describing physical or conceptual objects, such as persons, activities, locations, digital devices, etc. Each defined class may have parent and/or child classes (operating via a ‘is-a’ link) forming a hierarchy of related concepts. That is, each class may represent a concept. The parent and child classes may indicate relationships between concepts.

For example, a class named IndoorSpace may be a sub-class of Location, and may have four sub-classes Building, Room, Corridor and Entry. Each class may have multiple properties which describe features of that class and restrictions placed upon the class. For example, the class Location may have properties including longitude, latitude, temperature, noise level, etc. The class IndoorSpace may have properties such as lighting, humidity, etc. Further, the class Location may be a property of other classes, such as classes named Person, Activity and/or Device.

The ontology models may be used by logic reasoning mechanisms to deduce high level information from raw data and may enable system knowledge to be reused. This may be useful when modeling user relationships and user-app relationships. The user aspect information may be analyzed, remembered and reused later.

Ontology knowledge, as used herein, may predefine the related concepts and relationships. These concepts and relationships can provide an adaptable model that may be used across various application environments, thus improving user model versatility.

Based on the user profile information, the app profile information and the ontology knowledge, an R-knowledge network model may be generated (S506). The R-knowledge network model may be different from many existing network models that view interconnected data as homogeneous graphs or networks. The R-knowledge network model is a semi-structured heterogeneous information network model which leverages rich semantics of nodes and links. Thus, rich knowledge may be uncovered from the network.

The R-knowledge network model may be generated by a mutual enhanced users and apps learning module (e.g., relationship learning module 306). The relationship learning module 306 may receive the collected activity stream app data of users and collected app profile, process the collected activity stream app data in conjunction with auxiliary data to create a derived network for user and apps. The auxiliary data may include ontology knowledge describing a type or relationships of users, information about context information and parameters settings.

In an exemplary embodiment, a heterogeneous network may be defined as a directed graph G=(v, ε) with an object type mapping function π:v→V and a link type mapping function θ:ε→R, where each object v ∈ V belongs to a particular relation θ(ε) ∈ R. The relation type may include three categories: links between users, links between apps, and links between a user and an app. For example, a link may exist between two users indicating their relationships (e.g., friends, colleague); a link may exist between two apps when they are often used sequentially to fulfill certain tasks (e.g., saving a photo from a social network app to a cloud storage app) or when they have similar functions (e.g., games in a same category, shopping/educational apps having similar topics); and a link may exist between a user and an app based on activity stream app data of the user (e.g., adjusting sound profile when the user is at home/work, using an SNS app to send a message to another user). When two links belong to a same relation type, the two links share the same starting object type as well as the ending object type. The heterogeneous network (i.e., R-knowledge network model) may contain two types of objects, user denoted as U and app denoted as A. Further, UA denotes an app associated with a user and may be obtained from the user activity stream app data.

Each app A may have links to a set of users and other apps, belonging to a set of link types. Each user U may have links to a set of apps and other users. The learning step S506 may mine hidden relationships between users and apps from user activity data to build the heterogeneous network. That is, given user profile information and app profile information (e.g., user behavior data and app log information) as the input of the graphical model, links are mined and established by the graphical model. For example, a user may use an app (e.g., Linkedin) to send another user a message. The graphical model, then is capable to mine their relationships between these two users, thus, a link may be established between the two users indicating their relation type. As for apps, for example, a user app log information may be mined. When it is discovered two apps are always used together in certain context, a link may be established between the two apps indicating their relation type.

Further, the output of the graphical model may cluster users or apps together. For example, users having the same relation type may be clustered together, and apps having the same relation type may be clustered together. Such information may be used to enhance user experience in various applications.

In some embodiments, step S506 may further include building a user relationship topic model (S5062) and learning app relations (S5064). Further, the system may learn scalable relationships between users and apps. That is, the R-knowledge network model, the user relation topic model and the method of learning app relationships are all scalable to new users and apps.

Learning relationships between users may apply the notion that probability distribution of words in a user log may be expressed as a mixture of topics, where each topic is a probability distribution over words. The user relationship topic model may take user interest into account as well. Based on the topic distribution in the user log (e.g., text snippet obtained from the user activity app data), topics with high probabilities may be chosen as specific topics corresponding to the user.

For example, User U_{d} may write a text snippet denoted as d. The text snippet may be a text message, an email, or other texts collected by an app on the mobile device. For each word in the text snippet, a user may be chosen uniformly at random. Further, a topic may be chosen based on a distribution among topics specific to that user, and the word may be generated from the chosen topic.

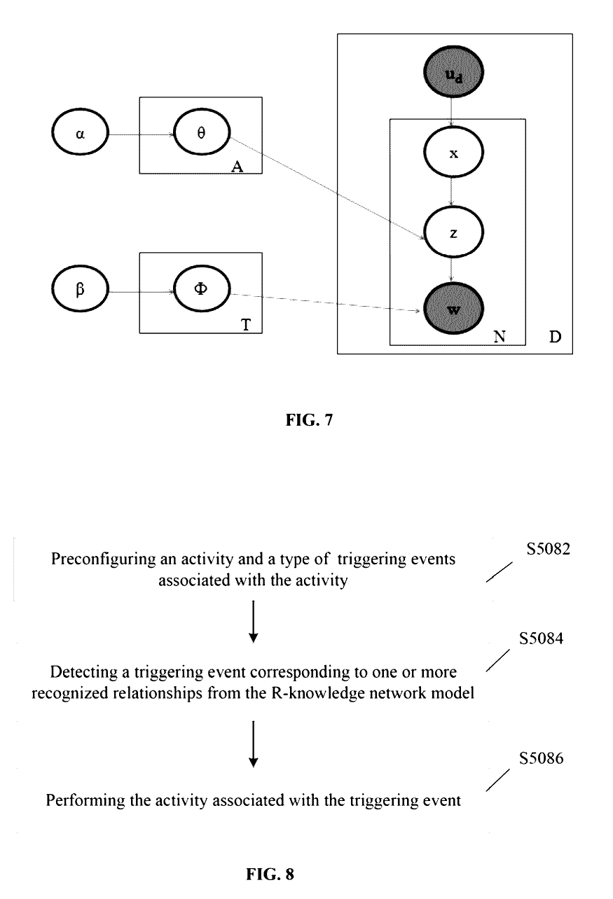

FIG. 7 illustrates a structural diagram of an exemplary user relationship topic model consistent with the disclosed embodiments. As shown in FIG. 7, U_{d} denotes the user responsible for a given word, chosen from a_{d}. a_{d} may denote the text snippet obtained from stream activity app data corresponding to a message written by the user. Each user is associated with a distribution over topics θ, chosen from a symmetric Dirichlet (α) prior. The mixture weights corresponding to the chosen user are used to select a topic z, and a word is generated according to the distribution φ corresponding to that topic, drawn from a symmetric Dirichlet(β) prior.

By estimating the parameters, information about which topics and words a user typically write about may be obtained. Further, ontology knowledge is used as controlled vocabulary to define the relationships corresponding to topics and words. For example, a pair of user topic vectors <meeting, office, schedule, work, . . . > and <due, project, deadline, . . . > may indicate a colleague relationship exist between two users. Thus, such information may be used in a classifier to classify hidden relationships between the sender and the receiver of a message. In some embodiments, Gibbs sampling may obtain parameter estimates under Dirichlet priors and allow combination of estimates from several local maxima of the posterior distributions.

Therefore, relationship between users may be found based on the user topic relationship model. Further, user topic relationship model is a generative model, which has the capabilities to handle big data. Thus, when new users and apps are added to the model, or when there are a large number of users and contexts to be processed, user topic relationship model may also be used. In some embodiments, step S5062 may be performed on a server or with cloud computation.

Returning to FIGS. 5 and 6, relationships between apps may be explored via app descriptions and user activities. The correlation between sequentially used apps may contribute to app relationship learning. In some embodiments, a Skip-gram model for learning high-quality vector representations of words from large amounts of unstructured text data may be applied.

Word representations computed using neural networks may capture many hidden linguistic regularities and patterns, which may generate linear translations of the features. For example, a vector calculated from vec(“Madrid”)−vec(“Spain”)+vec(“France”) is closer to vec(“Pairs”) than to any other word vector such as vec(“Berlin”) or vec(“Toronto Maple Leafs”). Similarly, each app may be treated as a word, and a sequence of apps launched on the mobile device within time T may be represented as a sentence.

In some embodiments, the problem of finding relationships between apps may be formulated as follows. Given a sequence of apps within time T (a₁ . . . a_{T}) as training data, the objective of the Skip-gram model is to maximize the average log probability described in expression (1):

$$\frac{1}{T} {\sum }_{t = 1}^{T} {\sum }_{- c \leq j \leq c j \neq 0} log p ( {a}_{t + j} \vert {a}_{t} ) \qquad ( 1 )$$

where c is the size of the training data. The basic Skip-gram formulation may define p(aₜ₊ⱼ|aₜ) using a softmax function (2):

$$p ( {a}_{o} \vert {a}_{j} ) = \frac{exp ( {{a}_{0}^{′ }}^{T} {a}_{j} )}{{\sum }_{a = 1}^{A} exp ( {{a}_{w}^{′}}^{T} {a}_{j} )} \qquad ( 2 )$$

where each a may be presented as a vector of features including Time, Latitude, Longitude, Context Trigger, Charge Cable, Audio Cable, App Function Description. After the model is trained, the distance between each pair of app function may be calculated. A pre-defined threshold may be given to filter out relationships between apps with low value.

Based on relationships between users and relationships between apps, an R-knowledge network model may be generated (S506), linking users and apps through the directed graph.

The mobile device may implicitly collect user log data periodically. The time interval may be every minute or may vary in different mobile devices depending on battery level of the device. Based on the user log data, user relationships and app connections may be updated in the R-knowledge network model. In some embodiments, the R-knowledge network model may be generated on the cloud.

The R-Knowledge network model may reflect relationships between users and apps systematically and provide a perspective to understand roles of users, use relationships and connections between apps in the existing digital ecosystem. The R-knowledge network model may be used to provide various functions to enhance user experience (S508).

FIG. 8 illustrates an exemplary process for using relationships among users and apps consistent with the disclosed embodiments. As shown in FIG. 8, an activity and a type of triggering events associated with the events may be preconfigured (S5082). The triggering events and the activity associated with the type of triggering events may be preset or defined by a user. The triggering event may include, for example, inputting a search query, calling an app function, interacting with a person in a specific group, the mobile device being at a specific location/time, etc.

After the R-knowledge network model is generated, a triggering event may be detected (S5084). The triggering event may correspond to one or more recognized relationships obtained from the R-knowledge network model. The recognized relationships may include relationships between users, relationships between apps, and relationships between users and apps.

Further, the activity associated with the triggering event may be performed (S5086). The activity may include, for example, presenting a search result, displaying a notification, automatically performing app functions, etc.

In one embodiment, the type of triggering events may be a search query, and the activity associated with the triggering events may be obtaining information from the R-knowledge network. The search query may ask about a role of a user, relationships of apps or a recommending apps list. In the generated R-knowledge network, a role of a user may be recognized by finding the relationship between the user and the mobile device owner.

Relationships of apps may be recognized based on links between apps, such as apps or app functions that often used together, app usage pattern of a user, apps with similar functions, etc. The recommending apps list may be recognized when apps have similar functions in the generated R-knowledge network. Further, the activity associated with the triggering event may be presenting the search result.

In another embodiment, the type of triggering events may be the mobile device owner is interacting with a user from a specific group (e.g., sending or receiving a communication with another user) or the mobile device owner is searching a user, the activity corresponding to the condition may be notifying the mobile device owner about their relationship. In some embodiments, besides notifying the mobile device owner about the relationship with the user, profile information of the user may be presented. Personalized settings on the interactions of the user may be applied. For example, the mobile device owner may configure personalized label, font, ringtone or other settings on users in a same relationship group.

In another embodiment, the type of triggering events may be a recognized app function sequence obtained from the R-knowledge network model. The activity associated with the triggering events may be prompting the user to allow automatic app function execution procedure in the future.

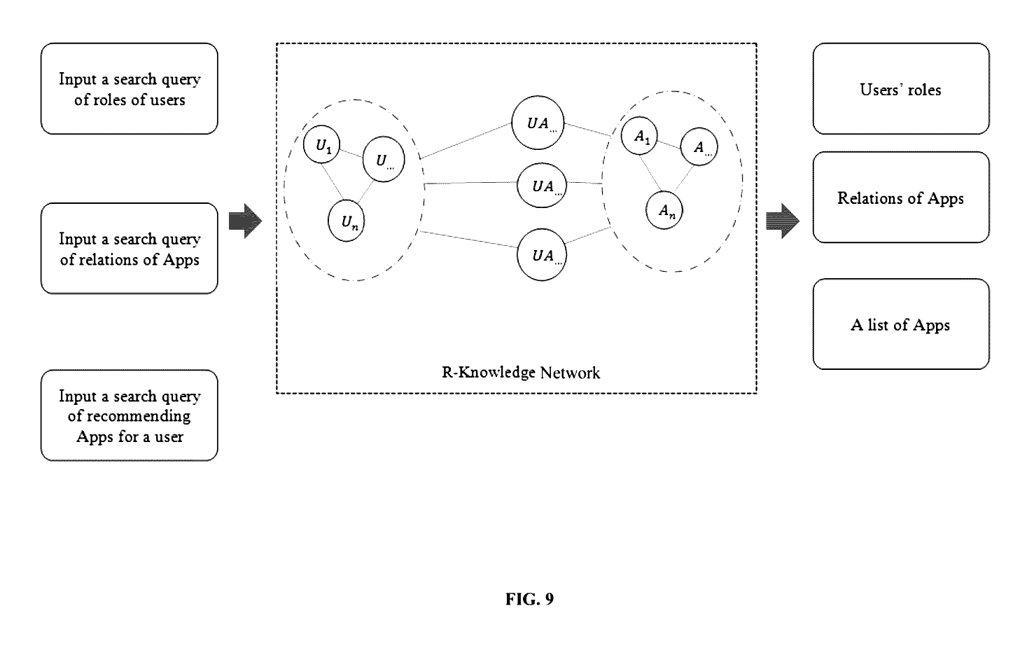

FIG. 9 illustrates usage scenarios of an exemplary R-knowledge network model consistent with the disclosed embodiments. When an R-Knowledge network model is built, different queries may be handled, such as the roles of users in the mobile network, the relationships between apps, a recommended apps list, etc. The results may be used for enhancing current user experience on the mobile device.

In some embodiments, the search query may be automatically triggered when a specific condition is satisfied. The specific condition may include the owner interacting with another person, such as sending or receiving a text message, an in-app message, an email, etc. Further, the predefined condition may include a specific time or location is reached, or a specific app function is performed.

User relationships learned by the R-knowledge network model may be used to enhance user experience. In one embodiment, assuming employee-employer relationship is not given in the contact list of the owner, but this relationship may be critical for user experience. The R-knowledge network model may learn such relationship. When the user receives a text message from his/her boss, the mobile device may recognize that the employee-employer relationship exists between them, and remind the user in an intrusive way.

Further, the R-knowledge network model may be used to connect apps automatically. For example, when the user is listening to music through a music streaming service (e.g., Spotify) and likes some interesting songs, this user activity may be automatically recorded to his/her personal blog site (e.g., Tumblr). In another example, when a weather app reports it is going to rain tomorrow, the user may get a notification via an email or a notification. In another example, when a social app (e.g., Facebook) gets a notification that the owner is tagged in a new photo, the photo may be automatically saved in a cloud storage app (e.g., Dropbox). Other examples may include adjusting sound profile when the user is at home/work or during the day/night, sharing a posted photo in one app to another app, etc.

In some embodiments, before the R-knowledge network model is built, these sequential or conditional activity patterns based on app relationships may be manually performed by the user. After the R-knowledge network model learns the activity patterns, the mobile device may prompt the user to allow automatic app function execution procedure. Thus, R-Knowledge may provide the capability to enhance user experience in the connected world.

In some embodiments, the search queries may be an active query inputted by the owner of the mobile device. For example, when the owner types in a name of a person as a search query, the mobile device may present related information of the person, including contact information, previous message/email exchanges, information on social network, and suggested role of the person from the R-knowledge network model. In another example, the owner may query specific properties to find a certain group of people, such as relationship type, nationality, occupation, location, etc.

Further, the search query may be a recommendation list of apps. In one embodiment, a search and recommender engine may combine information from the Internet (e.g., rankings in an App store, online app reviews) and the generated R-knowledge network model (e.g., recognized usage patterns and preferences of a user) to recommend an app list to a user. In another embodiment, the information from the Internet (e.g., rankings in an App store, online app reviews) may be previously acquired and inputted to the relationship learning module 306, thus the recommended list may be obtained directly from the generated R-knowledge network model. For example, the recommended app may perform functions that would normally accomplished by two installed apps. In another example, the recommended app list may include a personalized app list catered to user interest (e.g., games in a same category).

By using the disclosed methods and systems, a heterogeneous network may be automatically built and may bridge users and apps in real world via relationship learning. User relationships on a mobile device may be recognized by the discloses role discovery mining process (e.g., the R-knowledge network model, the user topic relationship model). The learned user relationships may be used to enhance our current user experience. Further, app relationships on the mobile device may be recognized. The learned knowledge may be served for many apps mining tasks. The discloses algorithms and models are scalable to new users and apps.

The disclosed methods and systems may build a heterogeneous network between user and app by leveraging user activity data on mobile operating system. Apps are put into a heterogeneous network, where nodes and relationships are of different types, studied with users' needs together. Information about users and information about apps are both profiled with scalability. With the disclosed R-Knowledge network model, several machining learning tasks may be performed in order to boost user experience, such as recommending new apps, clustering user group, etc. Although a mobile device is used in the discloses embodiments as an example, the disclosed methods and systems may be further extended to other devices, which also contains a heterogamous network, for the purpose of providing a unique user experience, such as a home automation system, an in-car intelligent system, etc.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

What is claimed is:

1. A method for learning and using relationships among users and apps on a mobile device, comprising:
collecting user profile information and app profile information on the mobile device, wherein the user profile information is associated with users including one or more owners of the mobile device and one or more people whose information have been accessed on the mobile device;
obtaining ontology knowledge on contexts and relationships, wherein the ontology knowledge includes a plurality of predefined concepts, features of the concepts, and relationships between the concepts;
generating a network model based on the user profile information, the app profile information and the ontology knowledge, wherein the network model is a heterogeneous information network model that links the users and the apps; and
outputting information based on the generated network model, wherein the outputted information includes at least one of a role of a user, a relationship between two apps or app functions, and a recommended apps list.

2. The method according to claim 1, wherein:
the network model is defined as a directed graph with an object type mapping function and a link type mapping function, wherein the object type includes one of users and apps;
a user has links to one or more other users and links to one or more apps; and
an app has links to one or more other apps and links to one or more users.

3. The method according to claim 1, wherein:
the user profile information of a user includes a digital representation of unique data about the user and user activity stream app data corresponding to the user;
the user activity stream app data is presented as a text snippet when generating the network model; and
the app profile information of an app includes text descriptions of the app and is presented as a text snippet when generating the network model.

4. The method according to claim 1, wherein:
the ontology knowledge includes a controlled vocabulary which is structured into a hierarchical taxonomy, wherein the controlled vocabulary includes the plurality of concepts represented as classes;
a class has at least one of a parent class and one or more child classes; and
a class is associated with properties that describe one or more features of the class and one or more restrictions placed upon the class.

5. The method according to claim 3, wherein generating a network model further includes learning relationships between users via a user relationship topic model, comprising:
obtaining a user text snippet from at least one of a text message, an email, and text collected by an app on the mobile device;
applying a topic model to express probability distribution of topics in the user text snippet, wherein each topic is a probability distribution over words;
choosing one or more specific topics based on the probability distribution; and
obtaining relationships of users corresponding to the user text snippet based on the specific topics and the ontology knowledge.

6. The method according to claim 1, wherein generating a network model further includes learning app relationships between apps according to correlations between sequentially used apps, wherein:
each app is represented as a word,
a sequence of apps launched on the mobile device within a preset time period is represented as a sentence; and
the word representations and the sentence representations are computed using a neural network to capture hidden linguistic regularities and patterns and to find relationships between apps.

7. The method according to claim 6, wherein:
provided that T denotes a number of apps launched on the mobile device within the preset time period, (a₁ . . . a_{T}) denotes the sequence of apps launched on the mobile device as training data, and c denotes a size of the training data,
a Skip-gram model is used to learn app relationships; and
an objective of the Skip-gram model is to maximize an average log probability described by:
$$\frac{1}{T} {\sum }_{t = 1}^{T} {\sum }_{- c \leq j \leq c j \neq 0} log p ( {a}_{t + j} \vert {a}_{t} ) .$$

8. The method according to claim 1, wherein:
the user profile information and the app profile information are implicitly collected periodically;
a time interval of collecting the user profile information and the app profile information varies based on a battery level of the mobile device; and
based on the collected user profile information and the collected app profile information, user relationships and app connections are updated in the network model.

9. A system for learning and using relationships among users and apps on a mobile device on a mobile device, comprising one or more processors configured to:
collect user profile information and app profile information on the mobile device, wherein the user profile information is associated with users including one or more owners of the mobile device and one or more people whose information have been accessed on the mobile device;
obtain ontology knowledge on contexts and relationships, wherein the ontology knowledge includes a plurality of predefined concepts, features of the concepts, and relationships between the concepts;
generate a network model based on the user profile information, the app profile information and the ontology knowledge, wherein the network model is a heterogeneous information network model that links the users and the apps; and
output information based on the generated network model, wherein the outputted information includes at least one of a role of a user, a relationship between two apps or app functions, and a recommended apps list.

10. The system according to claim 9, wherein:
the network model is defined as a directed graph with an object type mapping function and a link type mapping function;
the network model includes two types of objects: users and apps;
a user has links to one or more other users and links to one or more apps; and
an app has links to one or more other apps and links to one or more users.

11. The system according to claim 9, wherein:
the user profile information of a user includes a digital representation of unique data about the user and user activity stream app data;
the user activity stream app data is presented as text snippets when generating the network model; and
the app profile information of an app includes text descriptions of the app and is presented as text snippets when generating the network model.

12. The system according to claim 9, wherein:
the ontology knowledge includes a controlled vocabulary which is structured into a hierarchical taxonomy, wherein the controlled vocabulary includes a plurality of concepts represented as classes;
a class has at least one of a parent class and one or more child classes; and
a class is associated with properties that describe one or more features of the class and one or more restrictions placed upon the class.

13. The system according to claim 9, wherein when generating a network model, the one or more processor is further configured to learn relationships between users via a user relationship topic model, comprising:
obtaining a user text snippet from at least one of a text message, an email, and text collected by an app on the mobile device;
applying a topic model to express probability distribution of topics in the user text snippet, wherein each topic is a probability distribution over words;
choosing one or more specific topics based on the probability distribution; and
obtain relationships of users corresponding to the user text snippet based on the specific topics and the ontology knowledge.

14. The system according to claim 9, wherein when generating a network model, the one or more processor is further configured to learn app relationships between apps according to correlations between sequentially used apps, wherein:
each app is represented as a word,
a sequence of apps launched on the mobile device within a preset time period is represented as a sentence; and
the word representations and the sentence representations are computed using neural networks to capture hidden linguistic regularities and patterns and to find relationships between apps.

15. The system according to claim 14, wherein
provided that T denotes a number of apps launched on the mobile device within the preset time period, (a₁ . . . a_{T}) denotes the sequence of apps launched on the mobile device as training data, and c denotes a size of the training data,
a Skip-gram model is used to learn app relationships; and
an objective of the Skip-gram model is to maximize an average log probability described by
$$\frac{1}{T} {\sum }_{t = 1}^{T} {\sum }_{- c \leq j \leq c j \neq 0} log p ( {a}_{t + j} \vert {a}_{t} ) .$$

16. The system according to claim 9, wherein:
the user profile information and the app profile information are implicitly collected periodically;
a time interval of collecting the user profile information and the app profile information varies based on a battery level of the mobile device; and
based on the collected user profile information and the collected app profile information, user relationships and app connections are updated in the network.
